(19) United States
(12) Patent Application Publication
(10) Pub. No.: US 2005/0259683 A1
(43) Pub. Date: Nov. 24, 2005

(54) Control service capacity

(75) Inventors: Ellis Edward Bishop, Austin, TX (US); Randy Scott Johnson, O'Fallon, MO (US); Tedrick Neal Northway, Wood River, IL (US); H. William Rinckel, Prospect, CT (US); Matthew D. Shaw, Firestone, CO (US); Clea Anne Zolotow, Golden, CO (US)

Correspondence Address: IBM CORPORATION (RUS), C/O SIEGESMUND & ASSOCIATES, 4627 NORTH CENTRAL EXPRESSWAY, SUITE 2000, DALLAS, TX, 75206, US

(73) Assignee: International Business Machines Corporation, Armonk, NY (US)

(21) Appl. No.: 10/825,025

(22) Filed: Apr. 15, 2004

(51) Int. Cl. H04J 3/16; G06F 15/173; H04J 3/22

(52) U.S. Cl. 370/468

(57) ABSTRACT

A system and method is disclosed for managing information technology resources to provide processing capacity to multiple customers with varying requirements in a shared computing environment. The inventive process comprises producing and maintaining a capacity plan that allocates capacity resources, handling requests for additional capacity resources, and analyzing requests for additional capacity resources to identify issues that should be resolved in future allocations.

### BACKGROUND OF THE INVENTION

The invention disclosed herein is related generally to resource management, and particularly to managing information technology resources in a shared computing environment.

For many years, network technology has enabled the sharing of, and remote access to, computing resources around the world. One computer can readily exchange data with a computer down the hall or in another country. Of course, it did not take long for the business world to harness the power of global networks, and network technology has fueled the growth of an entire new industry focused on delivering services across these networks.

This new industry must be able to anticipate and meet customers' processing needs as their requirements grow, while maximizing existing resources. One method of maximizing resources is to allow customers to share computing and networking resources. In one implementation of this method, a service provider creates “logical” partitions of computing resources on primary processing units (commonly known as “mainframe” computers). Typically, a service provider contracts with several customers to provide a certain level of service to each customer, and creates or assigns a logical partition of resources to each customer to fulfill its obligations. One or more of the contracts, though, may allow for a margin of increase in the event of high peak usage. In the event of high usage by one customer, then, the service provider must be able to provide additional resources to that customer without adversely affecting any other customer resource utilization. To provide these additional resources, the service provider may re-allocate computing resources among various logical partitions until the customer's usage returns to normal. Allowing customers to share resources, though, requires the service provider to balance and monitor the shared resources carefully, so that the provider can meet all service obligations.

Several prior art methods address predictive resource allocation in one form or another. U.S. Pat. No. 5,918,207 issued to McGovern et al., for example, discloses a process and system for predictive resource planning that allows a service provider to meet a customer's predicted requirements for skilled workers. McGovern et al. disclose of process of evaluating the service provider's existing pool of workers, extrapolating a customer's technology direction to predict the customer's requirements, and creating individual development plans as needed in order to provide the predicted needs. The application of McGovern et al., however, is generally limited to managing human resources and does not address aspects of resource allocation that are unique to computing resources. Furthermore, McGovern et al. do not address the problem of sharing resources and the need to re-allocate resources to meet extraordinary demand. Similarly, U.S. Pat. No. 6,625,577 B1 issued to Jameson discloses a method for initially allocating resources, but does not provide a method that is suitable for responding to a customer's demand for additional resources in a shared computing environment.

Thus, there is a need for a detailed planning process for allocating available resources, anticipating the need for additional resources, and responding to a customer's demand for additional resources.

### BRIEF SUMMARY OF THE INVENTION

The invention disclosed below, referred to as the “Control Service Capacity,” provides a process and an apparatus for managing computing resources that allows a service provider to fulfill current and future obligations to multiple customers with varying requirements. In particular, the present invention encompasses the processes of producing and maintaining a capacity plan that allocates capacity resources in a shared computing environment, handling requests for additional capacity resources, and analyzing requests for additional capacity resources to identify issues that should be resolved in future allocations. As described in more detail below, this process is generally executed by a “Capacity Planner.”

The process of producing and maintaining a capacity plan comprises gathering capacity data, analyzing the capacity data to determine the need for additional capacity resources, allocating capacity resources so that existing and future service obligations can be met, gaining approval for the allocation, and notifying the service provider and the customer of the allocation. Capacity data is analyzed by extracting service obligations from a database, identifying the resources required to fulfill the service obligations, and comparing the required resources with existing resources to identify any service obligations that require additional capacity resources.

Requests for additional capacity resources are handled by extracting the requester's entitlements and standard data from a database, determining if the requester is entitled to have the request satisfied, and if so, obtaining any data that is required to satisfy the request, analyzing the capacity plan against actual usage data, and updating the capacity plan to reflect the result of the request for additional capacity resources.

The invention described in detail below enables a Capacity Planner to predict the type and quantity of customer resource requirements, and to predict the timing of these customer resource requirements. The Capacity Planner considers multiple factors to develop a solution, and weighs each factor in terms of its overall impact.

The Control Service Capacity invention enables (1) cost effective and efficient use of existing resources; (2) utilization of input such as trending data to project future platform/software acquisitions for new and/or existing customers; and (3) proactive planning based on trends and customer demands for services.

### BRIEF DESCRIPTION OF DRAWINGS

FIG. 1 is an overview of the Control Service Capacity process.

FIG. 2 illustrates the Handle Control Capacity Request sub-process.

FIG. 3 illustrates the Handle Service Entitlement Failure sub-process.

FIG. 4 illustrates the Analyze Commitments and Thresholds sub-process.

FIG. 5 illustrates the Analyze Trends sub-process.

FIG. 6 illustrates the Analyze Plan Against Actuals sub-process.

FIG. 7 illustrates the Investigate Deviations sub-process.

FIG. 8 illustrates Manage Capacity Data for Reporting sub-process.

FIG. 9 illustrates the Run Reports sub-process.

FIG. 10 illustrates the Produce/Maintain Capacity Plan sub-process.

FIG. 11 illustrates the Gather Data sub-process.

FIG. 12 illustrates the Forecast Resource Requirements sub-process.

FIG. 13 illustrates the Characterize and Size Workloads sub-process.

FIG. 14 illustrates the Determine and Apply Projection Methodology sub-process.

### DETAILED DESCRIPTION OF THE PREFERRED EMBODIMENT

The foregoing and other objects, features, and advantages of the invention will be apparent from the following more particular description of the preferred embodiment of the invention, as illustrated in the accompanying drawings wherein like reference numbers represent like parts of the invention.

In the detailed description that follows, the inventive Control Service Capacity process is carried out by a Capacity Planner. For the sake of clarity, the references to a Capacity Planner below assume that the Capacity Planner is an individual and that, unless otherwise indicated, the functions of the Capacity Planner are carried out manually. A person skilled in the art, though, will appreciate that many of the Capacity Planner's functions may be automated with routine programming, and the use of this nomenclature in the following description should not be construed as a limitation on the scope of the present invention.

Furthermore, as used herein, the term “Capacity Resource” includes, without limitation, a central processing unit (CPU), storage, memory, network or telecommunications hardware, and peripherals. A “Capacity Plan” is any document or database that substantially identifies Capacity Resources that are available or needed for any period defmed by a Capacity Planner, and substantially describes an allocation of the available or needed Capacity Resources during the defined period. A “Control Capacity Request” is any communication received by a Capacity Planner that indicates a need or an intention to acquire additional capacity resources or otherwise modify an existing allocation of capacity resources.

To effectively plan for and manage Capacity Resources based on future customer capacity requirements, a Capacity Planner must examine existing resource and workload obligations, as well as available resources and usage data. A person skilled in the art will appreciate that a Capacity Planner must also consider relevant policies, standards, and contracts when developing such a plan.

The present invention can be implemented in many different configurations, including software, hardware, or any combination thereof. The following detailed description of the preferred embodiment and the accompanying figures refer to a variety of software tools that a Capacity Planner may use to implement the inventive process. In particular, the accompanying figures illustrate the use of problem management software (TPM), reporting software (eSMRT or ESM/RT), and communications software (Notes). A person skilled in the art, though, will appreciate that a Capacity Planner may use a variety of software tools to implement the inventive process and apparatus, and the references to particular software tools are not intended to limit the scope of the invention. Furthermore, a person of skill in the art will be familiar with the various embodiments of particular software tools that are available in the market, and they are not described in detail here.

The following discussion and the accompanying figures also describe the use of databases in the preferred embodiment of the inventive process. A person of skill in the art will appreciate that a database may exist in many forms. As used herein, the term “database” means any collection of data stored together and organized for rapid search and retrieval, including vithout limitation flat file databases, fielded databases, full-text databases, object-oriented databases, and relational databases.

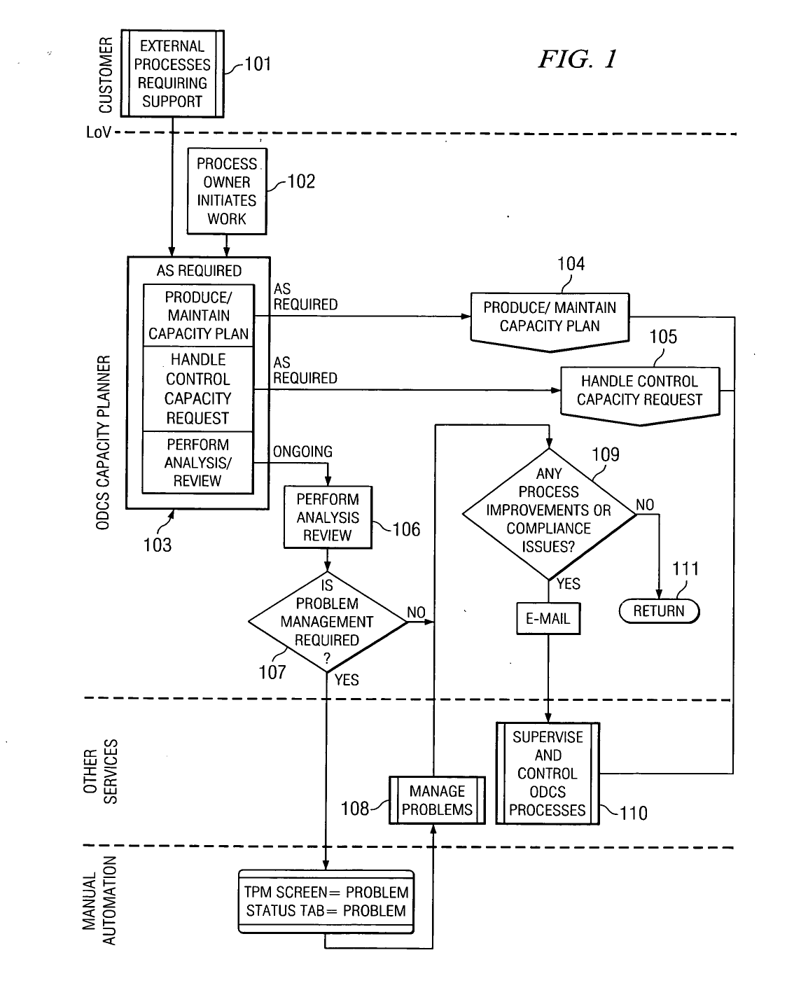

FIG. 1 provides an overview of the Control Service Capacity process. Generally, the Control Service Capacity process is invoked by an external process requiring support (i.e. a customer requesting additional capacity) (101), but may also be invoked by an internal process owner (i.e. a performance manager or customer service representative) (102). As illustrated in FIG. 1, a Capacity Planner initially selects the process path as required (103). The selections available to the Capacity Planner include producing or maintaining a Capacity Plan (104), handling a Control Capacity Request (105), and performing an analysis/review of Control Capacity Requests or issues to determine any areas of concern (106). The Capacity Planner's selection can depend on many factors, but is usually determined by the nature of the invocation.

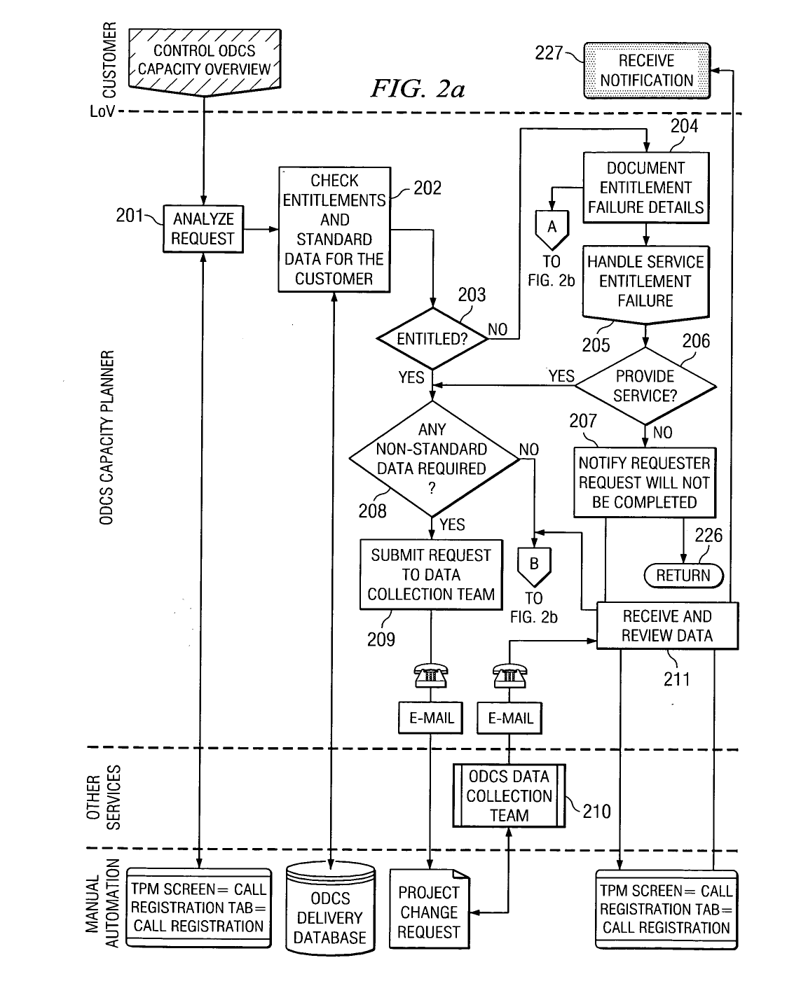

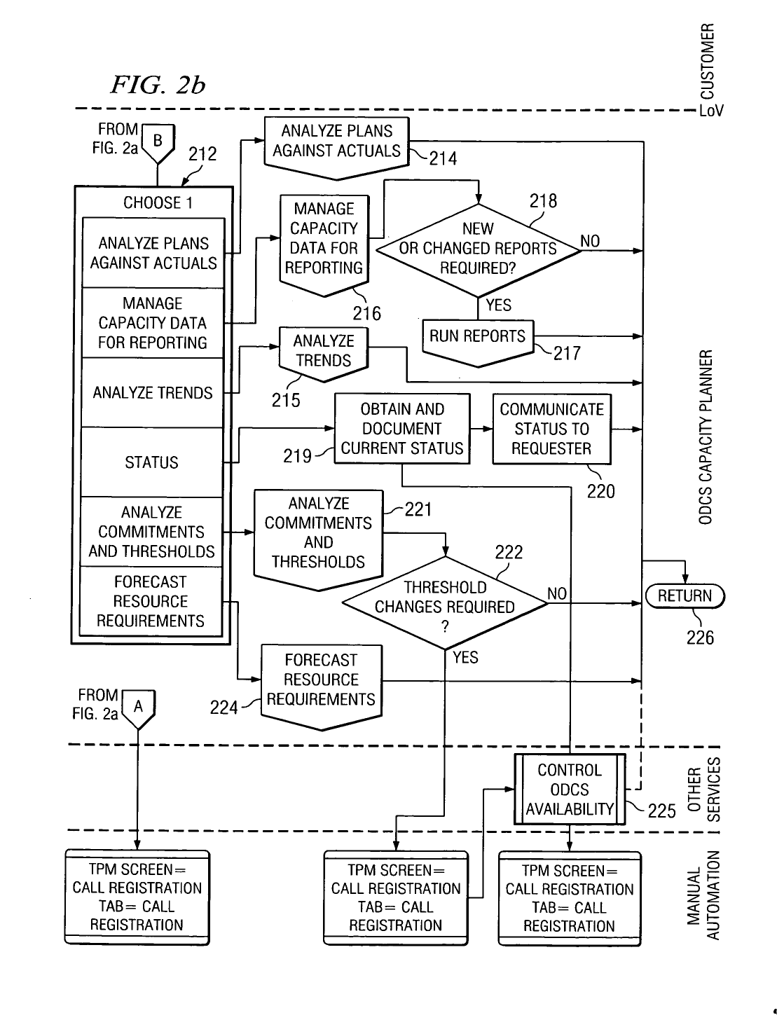

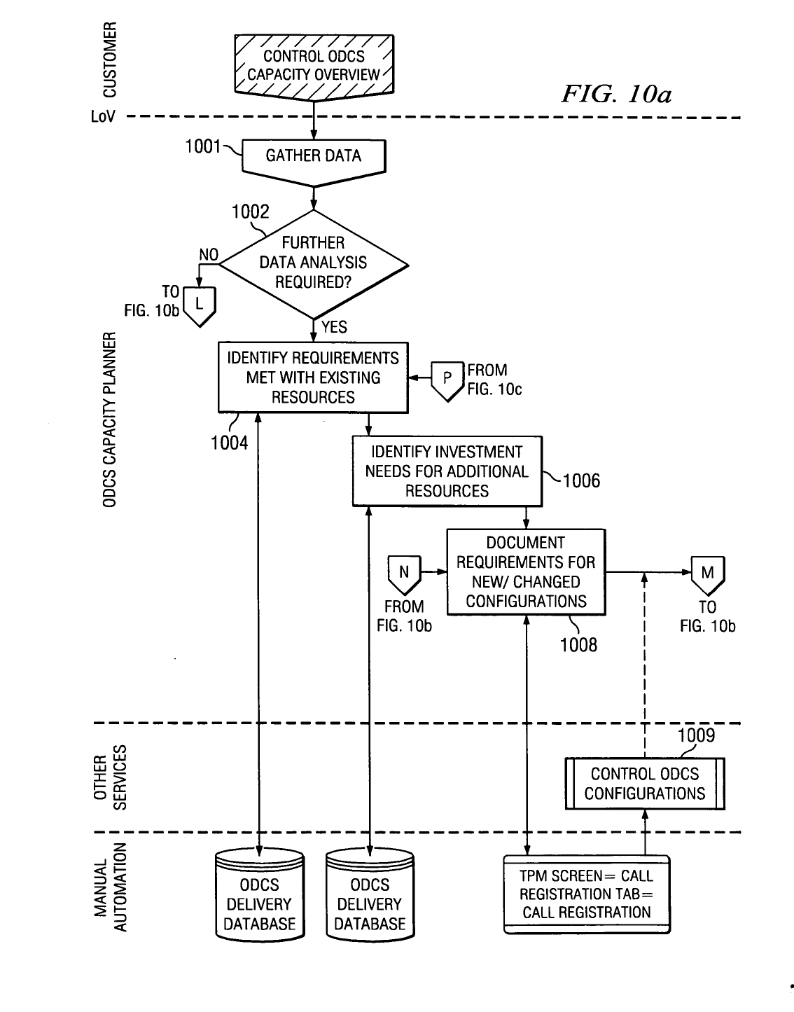

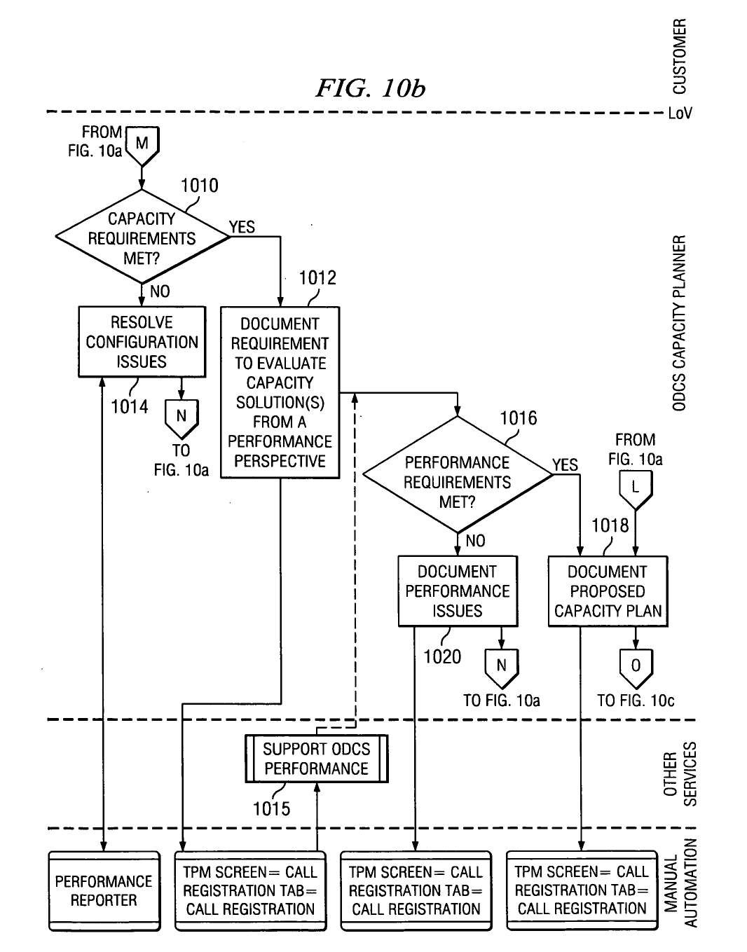

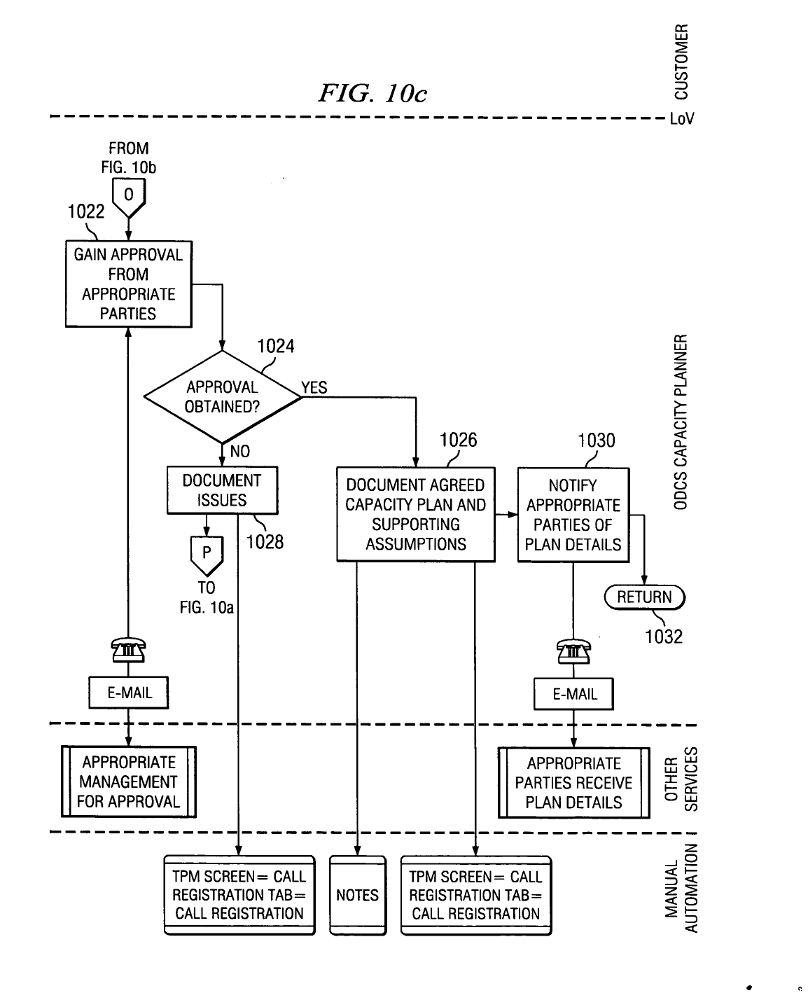

FIG. 2 illustrates the process of handling a Control Capacity Request. FIG. 10 illustrates the process of producing and maintaining a Capacity Plan. Each of these tasks is illustrated as a distinct sub-process in other figures and discussed in detail below.

As illustrated in FIG. 2, the Handle Control Capacity Request sub-process is invoked when a Capacity Planner receives a Control Capacity Request. The Capacity Planner first analyzes the request to understand the requirements (201). The Capacity Planner then reviews the customer's entitlements (202) to determine if the customer is entitled to receive the service or, at a minimum, entitled to make the request (203). The Capacity Planner must also review any standard capacity data available for the requesting customer. As seen in FIG. 2, a customer's entitlements and capacity data typically are-stored in a database to facilitate retrieval.

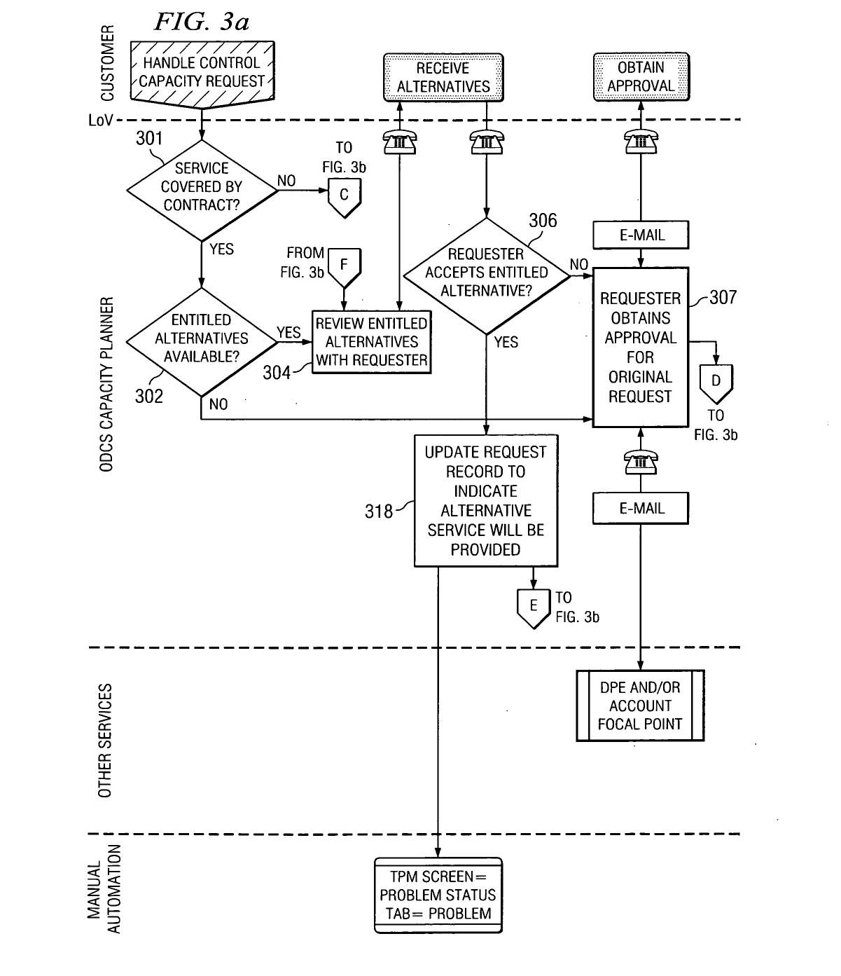

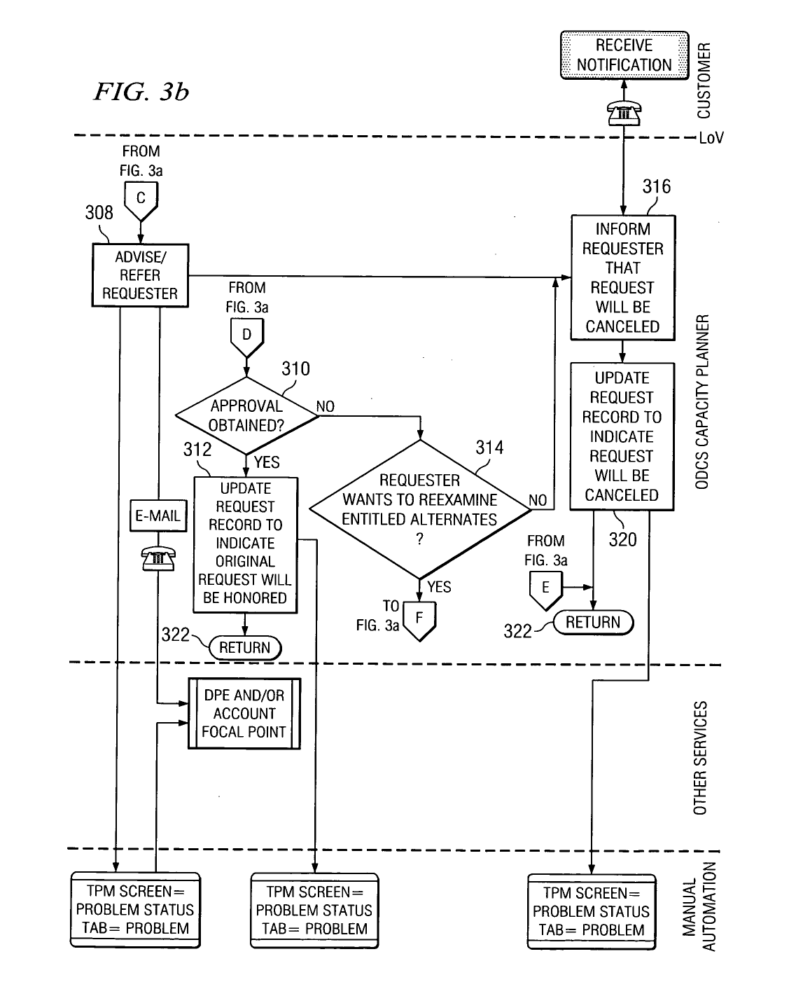

If the customer is not entitled to receive the service as requested, the Capacity Planner documents the details of the entitlement failure (204) in preparation for invoking the Handle Service Entitlement Failure sub-process (205), which is illustrated in FIG. 3 and described below. After processing the entitlement failure, though, the Capacity Planner determines if service is to be provided in spite of the failure (206). If the Capacity Planner determines that the service request should be denied, the Capacity Planner notifies a customer coordinator, and the customer coordinator notifies the requester that the request cannot be addressed (207). The Capacity Planner then closes the request.

If the customer is entitled to receive the service, the Capacity Planner then determines if the request requires data that is not standard (208). Generally, standard data comprises, without limitation, CPU minutes, disk storage, network bandwidth, and memory utilized for each customer by application. Caching is an example of non-standard data that might be required to resolve capacity planning issues. If required data is not currently provided, then the Capacity Planner submits a request for data to an appropriate data collection team (209). After acquiring the required data, the Capacity Planner chooses an appropriate course of action (212) from the following options: (1) Analyze Plans Against Actuals (214); (2) Manage Capacity Data for Reporting (216); (3) Analyze Trends (215); (4) Provide Request Status (219 & 220); (5) Analyze Commitments and Thresholds (221); or (6) Forecast Resource Requirements (224). Each of these options is illustrated as a separate sub-process and discussed in detail below.

FIG. 3 illustrates the Handle Service Entitlement Failure sub-process. The objective of this sub-process is to resolve entitlement failures for requested services. The Handle Service Entitlement Failure sub-process is governed by all local policies relating to handling service entitlement failures. The Handle Service Entitlement Failure sub-process includes the following activities: reviewing the specifics of the entitlement failure and the associated entitlement policy; investigating any entitled alternatives to the requested service; reviewing all entitled alternatives with the requester; and gaining acceptance from the requester for an entitled alternative or have the requester obtain approval from the appropriate parties for the original request. If the requester does not accept an entitled alternative or does not gain the proper approval for the original request, the Capacity Planner must inform the requester that the request has been rejected and that the associated request record will be closed.

As shown in FIG. 3, the Handle Service Entitlement Failure sub-process requires the Capacity Planner to determine if the requested service is covered by a service agreement or contract (301). If the request is not covered by an agreement, the Capacity Planner should follow local policy to advise the requester on how to proceed with the request (308).

If the overall service is covered by an agreement but the specific request is not, the Capacity Planner determines if any entitled alternatives are available (302). If entitled alternatives are available, then the Capacity Planner reviews all entitled alternatives to the requested service with the requester (304). If the requester accepts an entitled alternative, then the Capacity Planner updates the request record to indicate the specifics of the entitled alternative solution that will be provided (318). If, however, the requester does not accept the entitled alternative, then the Capacity Planner follows local policy to have the requester obtain approval for the original request (307).

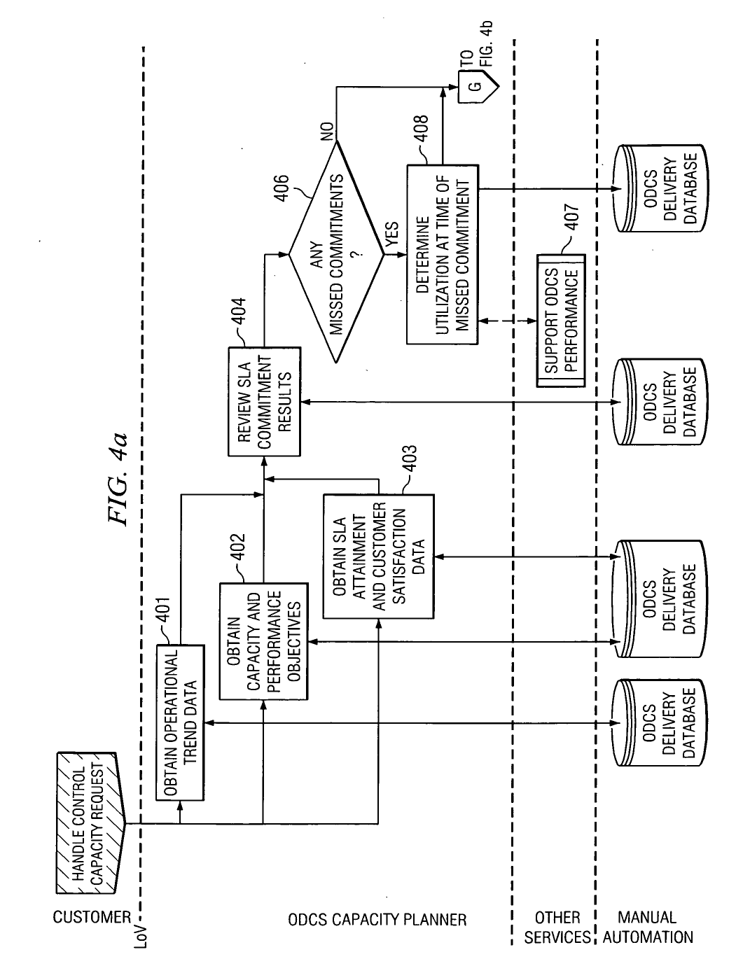

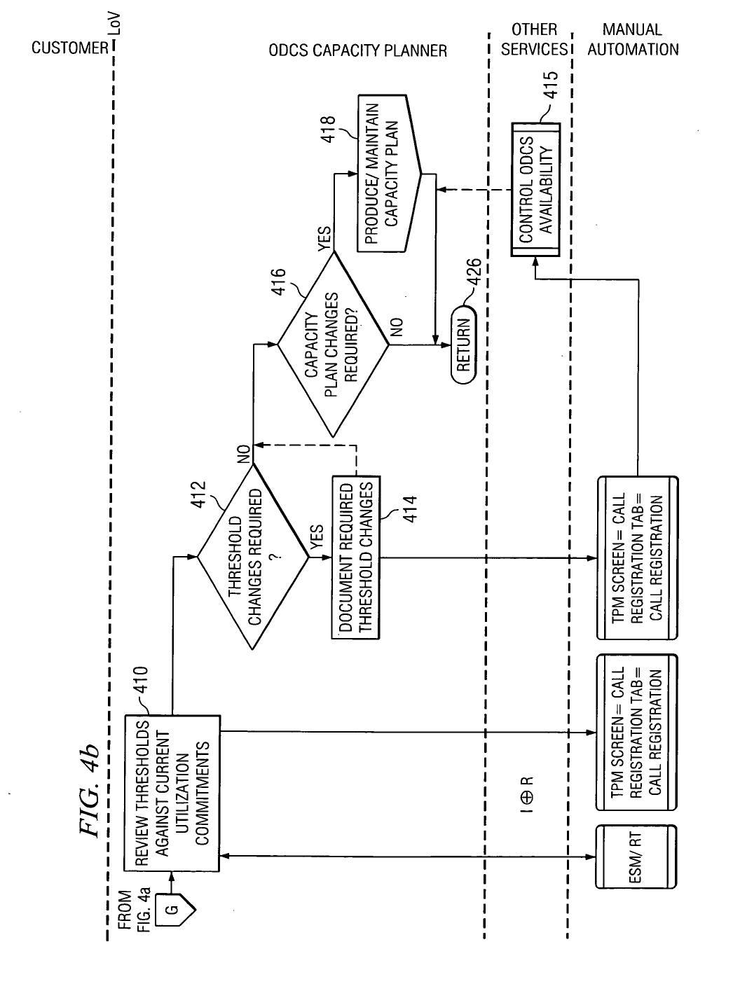

FIG. 4 illustrates the Analyze Commitments and Thresholds sub-process. The objective of the Analyze Commitments and Thresholds subprocess is to establish thresholds and to identify needs for actions based on service agreements. As shown in FIG. 4, this sub-process is invoked from the Handle Control Capacity Request sub-process. When invoked, the Capacity Planner first acquires operational trend data, capacity objectives, performance objectives, service level attainment data, and customer satisfaction data (401 thru 403). Operational data is the standard data, as described above, which includes CPU minutes, disk storage, etc. used by each customer. Capacity and performance objectives include customer support goals (e.g., desired response time and other service levels). The objectives guide the development of the thresholds. The Capacity Planner then reviews the results (404) and determines if any commitments have been missed (406).

If commitments have been missed, the Capacity Planner determines what the utilization was at the time of the missed commitment (408). If no commitments have been missed, the Capacity Planner determines the peak utilization that would cause a missed commitment (410).

The Capacity Planner then determines if there is a need to change current thresholds (412). Generally, thresholds need to be changed if customer objectives were missed or if the existing threshold did not provide enough advance notice to resolve a capacity issue. For example, if the threshold for CPU usage was set to 90% but actual usage went to 98% before the Capacity Planner could resolve the issue, then the Capacity Planner may determine that the threshold should be moved downward to 85% to avoid the same impact in the future.

If the Capacity Planner identifies a need to change current thresholds, the Capacity Planner must identify all required changes to the thresholds (414). If no changes to thresholds are necessary, then the Capacity Planner determines if any changes are needed to the Capacity Plan (416). If changes to the Capacity Plan are needed, the Capacity Planner invokes the Produce/Maintain Capacity Plan sub-process (418) (described in detail below.) The process flow then returns to the Handle Control Capacity Request sub-process.

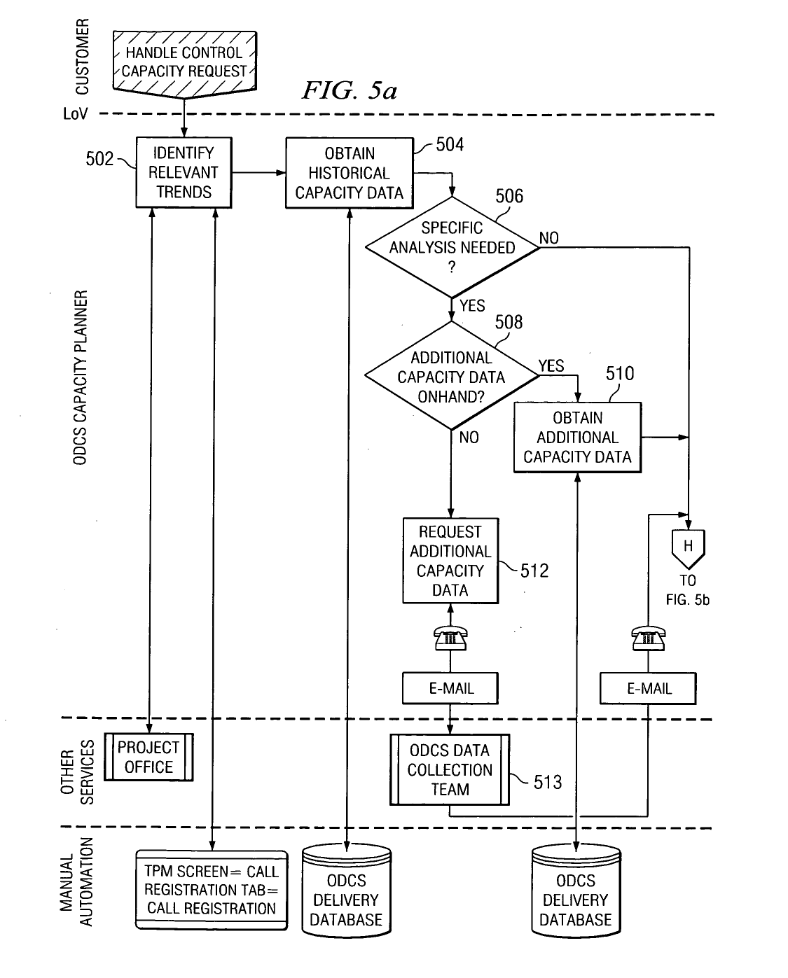

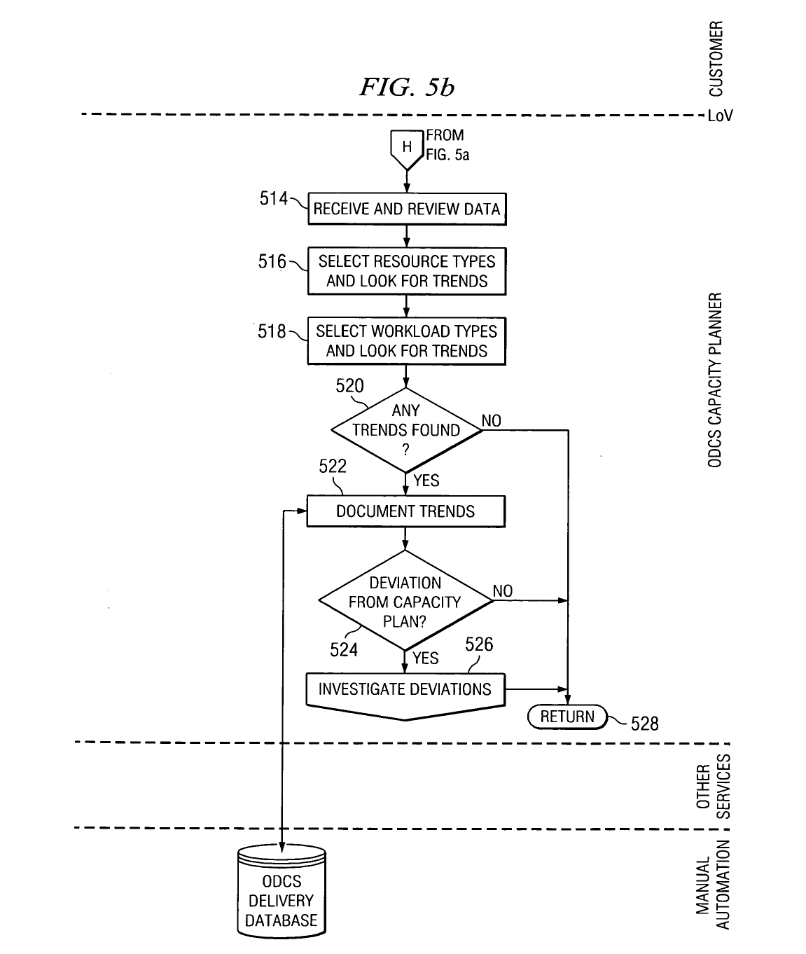

FIG. 5 illustrates the Analyze Trends sub-process. As seen in FIG. 5, the Analyze Trends sub-process is invoked from the Handle Control Capacity Request sub-process. The objective of the Analyze Trends sub-process is to interpret data to produce meaningful information to support and develop capacity decisions for the service provider. In addition to trending, unique utilization characteristics that may have significant impact on current and future resource utilization are noted. This is an iterative process that validates usage patterns as they relate to projected patterns. Discrepancies are identified and actions are taken to resolve the differences.

The Analyze Trends sub-process requires the Capacity Planner to analyze actual usage data of resource elements to understand the direction of a trend, if any, to be used for future capacity control decisions (502). This step validates specific usage of resource elements as they relate to groupings of interest. After analyzing actual usage data, the Capacity Planner then obtains all historical capacity data from all available resources (504).

The Capacity Planner then determines if a specific analysis is required (506). The Capacity Planner normally invokes a specific analysis in response to a system problem where the standard data may not provide the information required for resolution. Examples of specific analyses that the Capacity Planner may invoke include, without limitation, CPU usage by a specified user and growth of storage for an individual application.

If the Capacity Planner determines from the historical capacity data that a specific analysis is needed, then the Capacity Planner requests the needed capacity data from an appropriate data collection team (508 and 512). The data collection team (513) then obtains and returns the needed capacity data to the Capacity Planner. The Capacity Planner then reviews the capacity data for accuracy (514).

If the Capacity Planner does not determine that a specific analysis is needed, or after the Capacity Planner receives and reviews needed capacity data provided by the data collection team, the Capacity Planner examines resource types and workload types for identifiable usage patterns (516, 518, and 520).

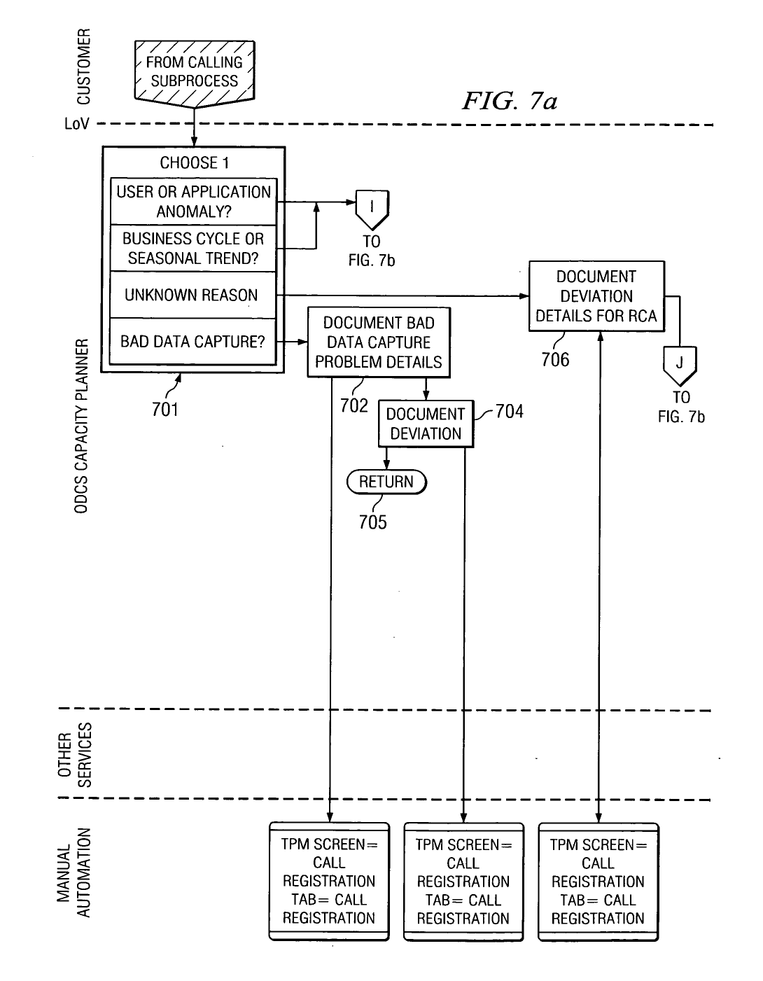

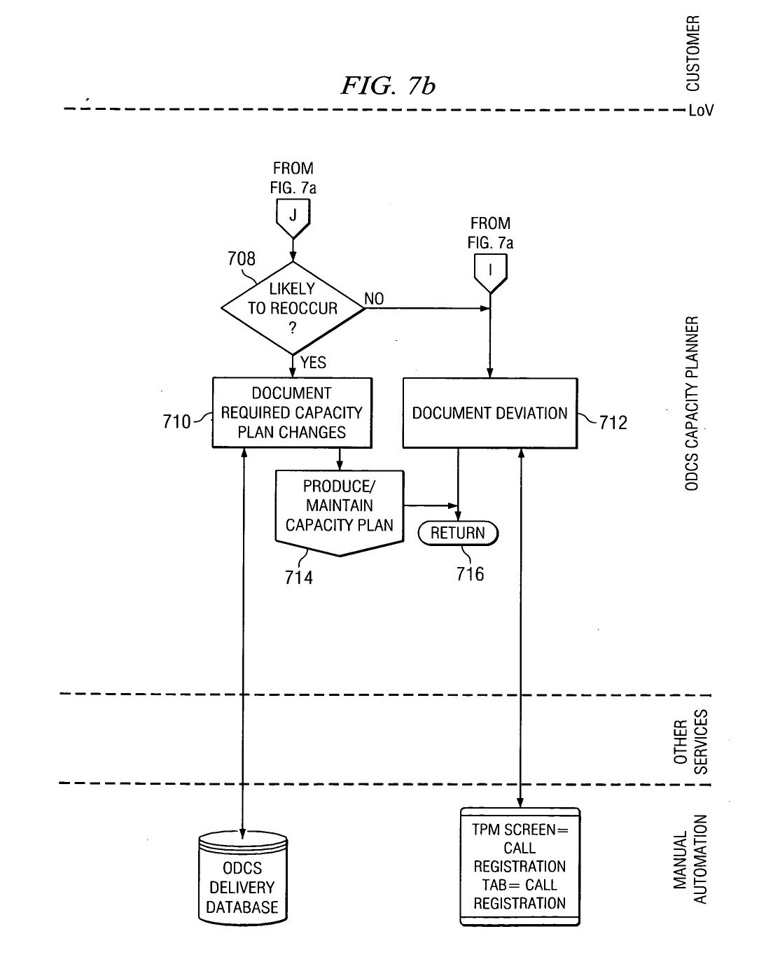

If the Capacity Planner identifies any trends, then the Capacity Planner must document the trends (522). If, during the process of documenting the trends, the Capacity Planner identifies any deviations from the Capacity Plan (524), then the Capacity Planner must invoke the Investigate Deviations sub-process (526) before returning to Handle Control Capacity Request. The Investigate Deviations sub-process is illustrated in FIG. 7 and described in detail below.

If no trends were found, then the process returns to the Handle Control Capacity Request sub-process (528).

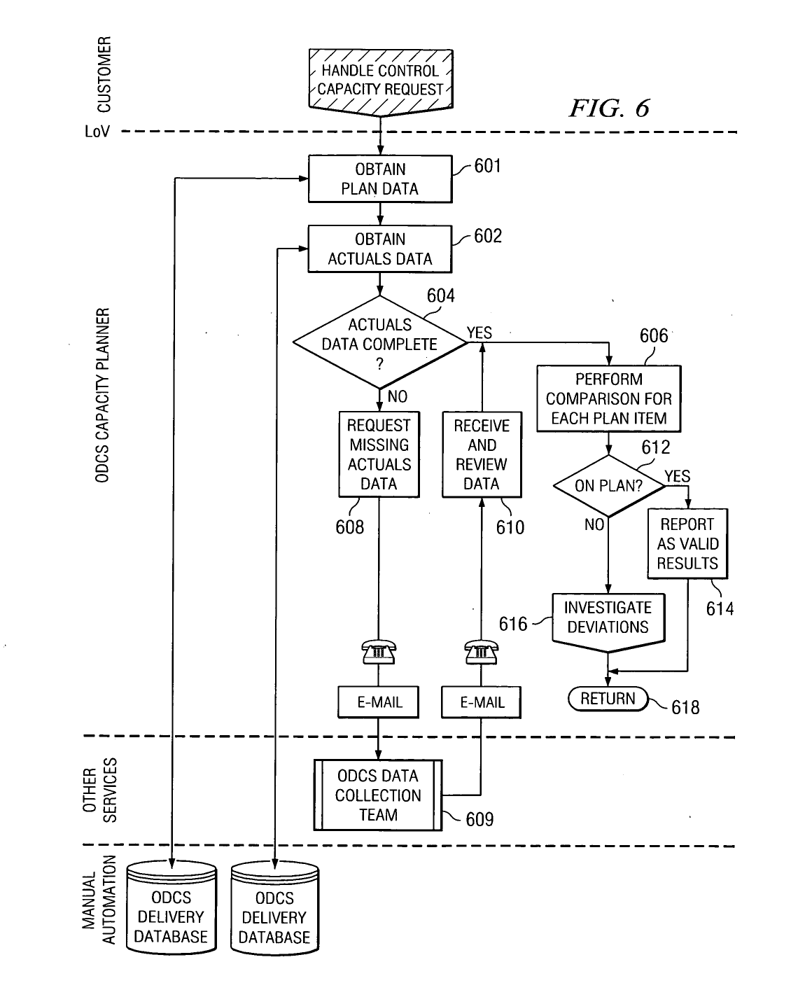

FIG. 6 illustrates the Analyze Plan Against Actuals sub-process. As seen in FIG. 6, the Analyze Plan Against Actuals sub-process is invoked by the Handle Control Capacity Request sub-process. The objective of the Analyze Plan Against Actuals sub-process is to analyze the capacity plan against actual measured data for a specific plan period, and to identify elements of the plan where further investigation is required.

Also as seen in FIG. 6, the Capacity Planner begins the analysis by obtaining the Capacity Plan (601) and actual data (602). The Capacity Planner then determines if the actual data is complete (604). If the data is not complete, then the Capacity Planner must request the missing capacity data (608) from the appropriate data collection team 609. Upon receiving the requested data from data collection team 609, the Capacity Planner must review it for accuracy (610).

Once the actual data is complete, the Capacity Planner performs a comparison for each plan item (606). The Capacity Planner analyzes and correlates utilization data as it relates to performance objectives, service level attainment, and customer satisfaction. The Capacity Planner derives thresholds from the point, actual or calculated, where an increase in resource utilization over a particular level directly causes missed service level commitments. That level is then noted as the “plan line” threshold for a given system environment.

If the actual data follows the plan, then the Capacity Planner reports that the results are valid (614), and the process continues in the Handle Control Capacity Request sub-process (618).

If the actual data does not follow the plan, then the Capacity Planner invokes the Investigate Deviations sub-process (616) to investigate any deviations from the Capacity Plan. The Investigate Deviations sub-process is illustrated in FIG. 7 and described in detail below. After any deviations are investigated, the process continues in the Handle Control Capacity Request sub-process (618).

FIG. 7 illustrates the Investigate Deviations sub-process. As seen in FIG. 7, the Investigate Deviations sub-process can be invoked by a variety of other sub-processes. The objective of the Investigate Deviations sub-process is to examine those parts of the Capacity Plan that could not be validated, explain deviations, and, if necessary, initiate actions to resolved the deviations.

In the Investigate Deviations sub-process, the Capacity Planner must determine the nature of the deviation before taking action (701). In general, if the deviation is unlikely to re-occur, then the Capacity Planner classifies and reports the deviation as an anomaly, and the deviation is documented (but no further action is taken) (706, 708, and 712). If the deviation is a result of a business cycle or seasonal trend, then the deviation is documented (712). In some instances, though, the deviation may be the result of bad data capture. If the Capacity Planner determines that the deviation is, in fact, the result of bad data capture, the details of the bad data capture are documented (702). If the reason for the deviation is not known, then the details of the deviation are documented for a root cause analysis (706), and the Capacity Planner must determine if the deviation is likely to occur again (708). If the Capacity Planner determines that the deviation is likely to re-occur, then the Capacity Planner documents the changes that will be needed to the Capacity Plan to address the deviation (710). After documenting the necessary changes, the Capacity Planner invokes the Produce/Maintain Capacity Plan sub-process to update the Capacity Plan (714). The Produce/Maintain Capacity Plan sub-process is illustrated in FIG. 10 and described in detail below.

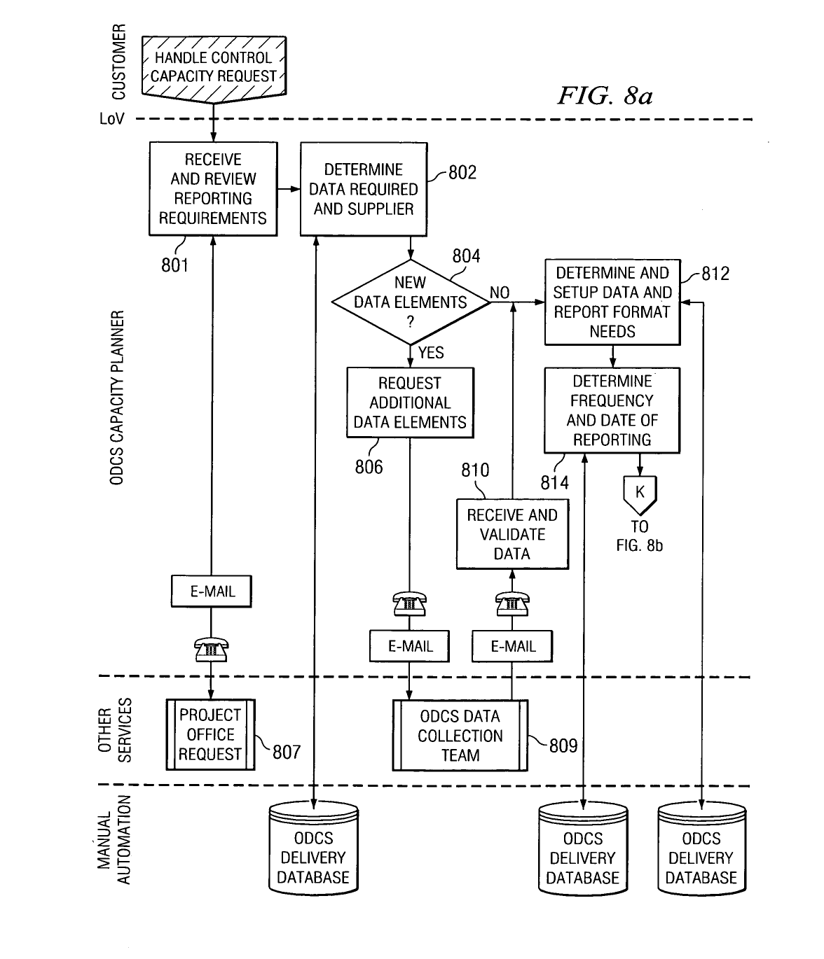

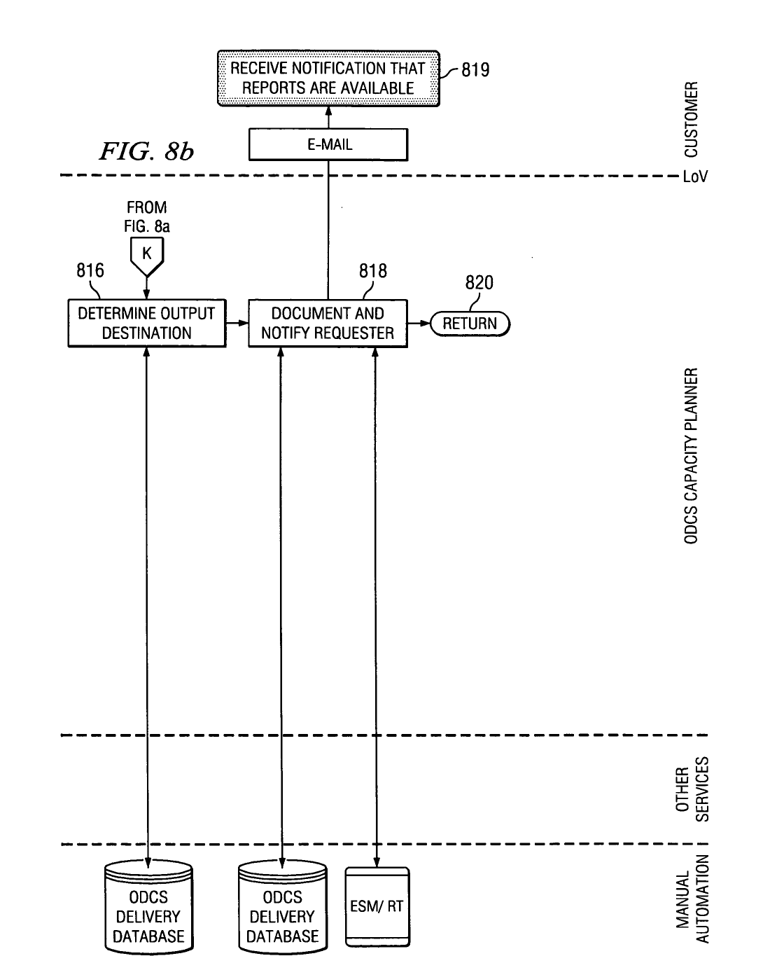

FIG. 8 illustrates the Manage Capacity Data for Reporting sub-process. As seen in FIG. 8, the Manage Capacity Data for Reporting sub-process is invoked by the Handle Control Capacity Request sub-process. The objective of the Manage Capacity Data for Reporting sub-process is to handle the need for a new report, from the request to how it will be delivered.

In the Manage Capacity Data for Reporting sub-process, the Capacity Planner first reviews the reporting requirements submitted (generally based on contracted service level commitments to a customer or customers) to determine the most accurate reporting solution for the request (801). Then the Capacity Planner determines what data is required and who will supply the required data (802). If any new data elements are required to produce the requested report (804), then the Capacity Planner requests the needed additional data elements from an appropriate data collection team 809 (806). Data collection team 809 then gathers the requested data and provides it to the Capacity Planner. The Capacity Planner receives the requested capacity data from data collection team 809 and reviews it for accuracy (810).

After acquiring all the necessary data, the Capacity Planner determines and sets up the data and the report format based on the needed formats (812). The Capacity Planner then determines the frequency of the reporting and any specific dates for the reporting (814), and where the output will be received (816). When the reporting is complete, the Capacity Planner notifies the requester (818) and the requester receives the data (819).

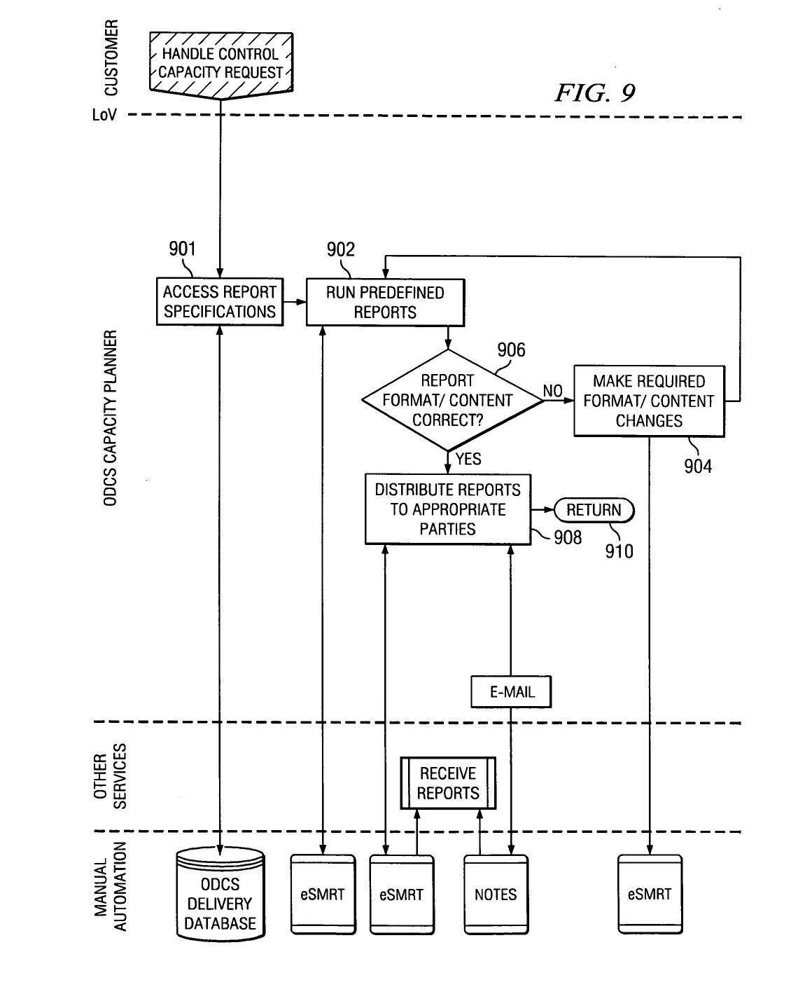

FIG. 9 illustrates the Run Reports sub-process. As seen in FIG. 9, the Run Reports sub-process is invoked from the Handle Control Capacity Request sub-process. The Capacity Planner initiates the Run Reports sub-process by retrieving the capacity report specifications (901) from a database or other storage medium. The Capacity Planner then runs pre-defined reports (902) and determines if the format and content of the report are correct (906). If the format and content of the report are correct, then the Capacity Planner distributes the reports to appropriate parties (908). In the preferred embodiment, the Capacity Planner uses a web-enabled reporting tool such as eSMRT. A reporting tool such as eSMRT typically consists of information, transport, database, and presentation layers that provide account management and support groups a means to view the status of their business via operational, dashboard and service level reports. Also in the preferred embodiment, the Capacity Planner uses an electronic messaging system such as LOTUS NOTES to distribute the reports. If the format or report is not correct, then the Capacity Planner makes the required changes (904) and re-runs the reports before distributing the reports to the appropriate parties (902).

FIG. 10 illustrates the Produce/Maintain Capacity Plan. The Produce/Maintain Capacity Plan sub-process may be invoked by the main process or one of several sub-processes, as discussed above. The objective of the Produce/Maintain Capacity Plan is to develop, maintain, test, and revise a Capacity Plan that allows a service provider to fulfill all current and foreseeable service obligations.

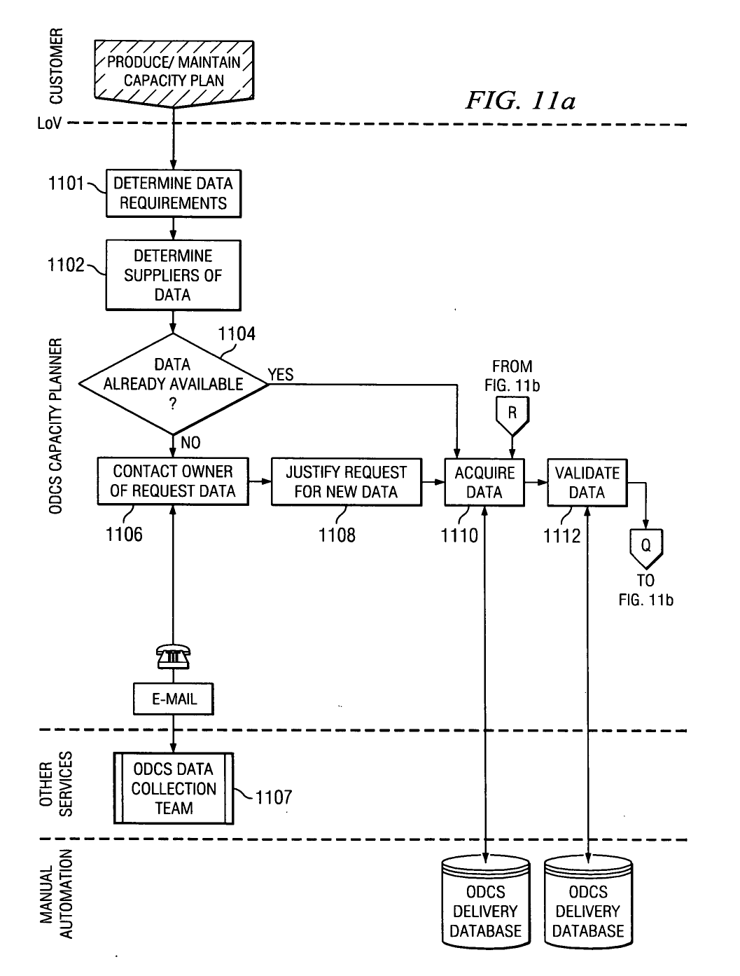

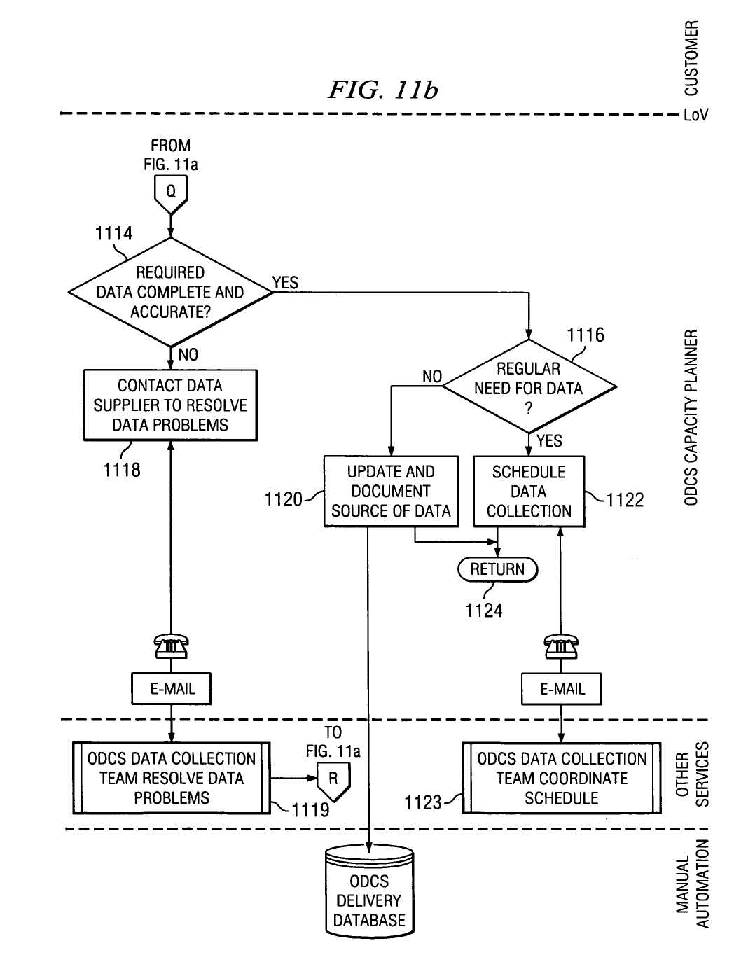

The Produce/Maintain Capacity Plan initially invokes the Gather Data sub-process (1001), which is illustrated in FIG. 11 and described in detail below. The Gather Data sub-process (1001) produces the data required to produce or maintain the Capacity Plan. The Capacity Planner then determines if additional capacity data analysis is required (1002). Additional capacity data analysis covers non-standard data—data that is not generally employed in capacity planning. For example, data showing task control block versus the system resource block time used is not generally collected or kept for capacity planning. This data is required when moving workloads to smaller CPU engines.

If the Capacity Planner determines that additional capacity data analysis is required, then the Capacity Planner identifies the requirements, if any, that can be met with existing resources (1004). In order to identify these requirements, the Capacity Planner must consider the total plan period, and the following factors for each resource type: workload peaks, projected loads, workload dependencies, and applicable controls. After identifying the requirements that can be met with existing resources, the Capacity Planner must identify investment needs for additional resources (1006). The Capacity Planner must also document the details of any new or changed configurations required to meet capacity requirements (1008).

In one embodiment, the Capacity Planner then invokes an external operational process to design and plan configurations that satisfy any modified capacity requirements (1009). The purpose of this external operational process is merely to confirm that the workload balancing of any new or changed configurations is acceptable from a configuration standpoint. The details of this operational process, however, are not essential to the present invention and are not described here. A person of skill in the art will appreciate that the present invention will still function without this intermediate step. If the Capacity Planner invokes this external operational process, however, then the Capacity Planner would also determine if the new configuration plan adequately addresses all capacity issues. If not, then the Capacity Planner would iteratively attempt to resolve the configuration issues and invoke the external operational process until all issues were adequately resolved.

Similarly, one embodiment allows the Capacity Planner to invoke another external process to evaluate the proposed Capacity Plan from a performance perspective (1015). The purpose of this external process is to model the proposed solutions to determine the impact on the components of the solutions during the plan period. Again, a person of skill in the art will appreciate that the present invention will still function without this intermediate step. If, however, this external process is used and the results indicate that some performance requirements would not be met, the Capacity Planner should document the failure and iterate through the sub-process as indicated in FIG. 10.

The Capacity Planner then documents the proposed Capacity Plan (1018) in preparation for gaining commitment from the appropriate parties (1022 and 1024). If approval from the appropriate parties is not obtained, the Capacity Planner should document any issues resulting in the failure to obtain approval (1028) and iterate through the process as indicated in FIG. 10. Otherwise, the Capacity Planner documents the agreed Capacity Plan and any supporting assumptions (1026). In the preferred embodiment, the agreed Capacity Plan has several levels of detail. It includes information that shows the impact of the projected workload on the system resources over the projected period of time. It also includes the list of factors that were taken into consideration to justify and clarify the resources required in the agreed Capacity Plan. After documenting the agreed Capacity Plan, the Capacity Planner notifies all appropriate parties of the details of the plan (1030).

FIG. 11 illustrates the Gather Data sub-process. As indicated above and noted in FIG. 11, the Gather Data sub-process is invoked by the Produce/Maintain Capacity Plan. The objective of the Gather Data sub-process is to gather data required for capacity analysis, and to ensure that standard data is collected on a regular basis. The Capacity Planner begins the Gather Data sub-process by determining what data is needed for analysis and reporting (1101), and determining the best source for the data (1102).

If the data is not already available, the Capacity Planner requests data access from the data owner (1106) and provides justification for the data (1108). If the data is already available, or if the data owner has provided data access, then the Capacity Planner acquires the data from the owner (1110). The Capacity Planner then reviews the data for accuracy and completeness (1114). If the required data is not complete and accurate, then the Capacity Planner contacts the data supplier to correct missing or inaccurate data (1118) and iterates through the process as indicated in FIG. 11.

If the Capacity Planner determines that there is a regular need for the data (1116), then the Capacity Planner schedules the data to be collected on a regular schedule (1122). Otherwise, the Capacity Planner documents the source of the capacity data in case of similar requirements in the future (1120).

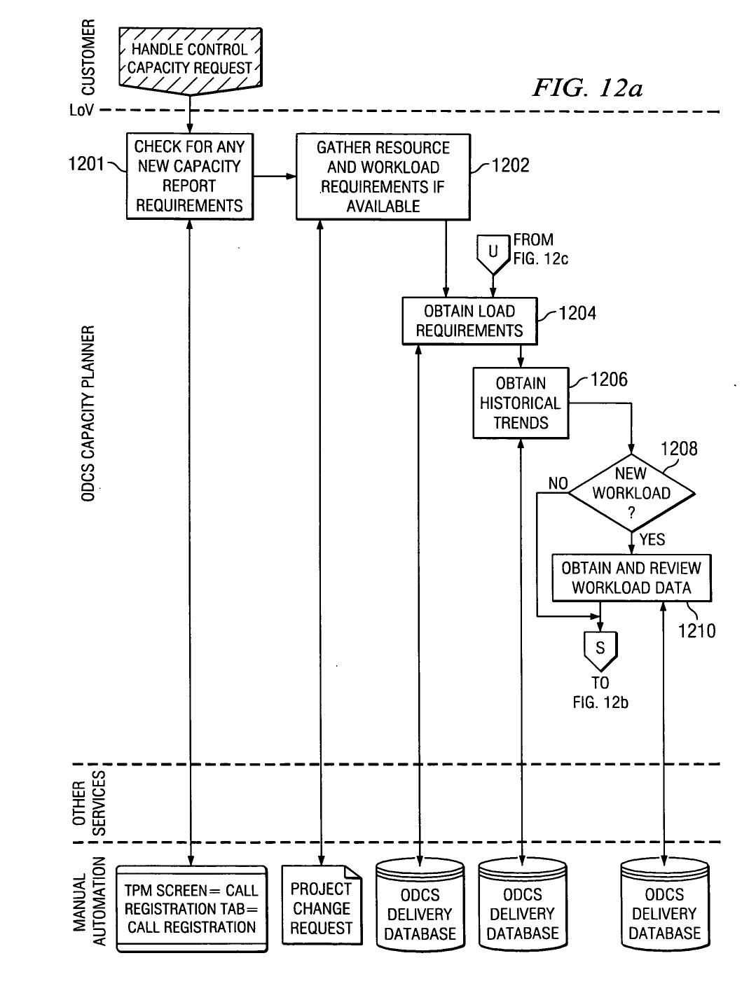

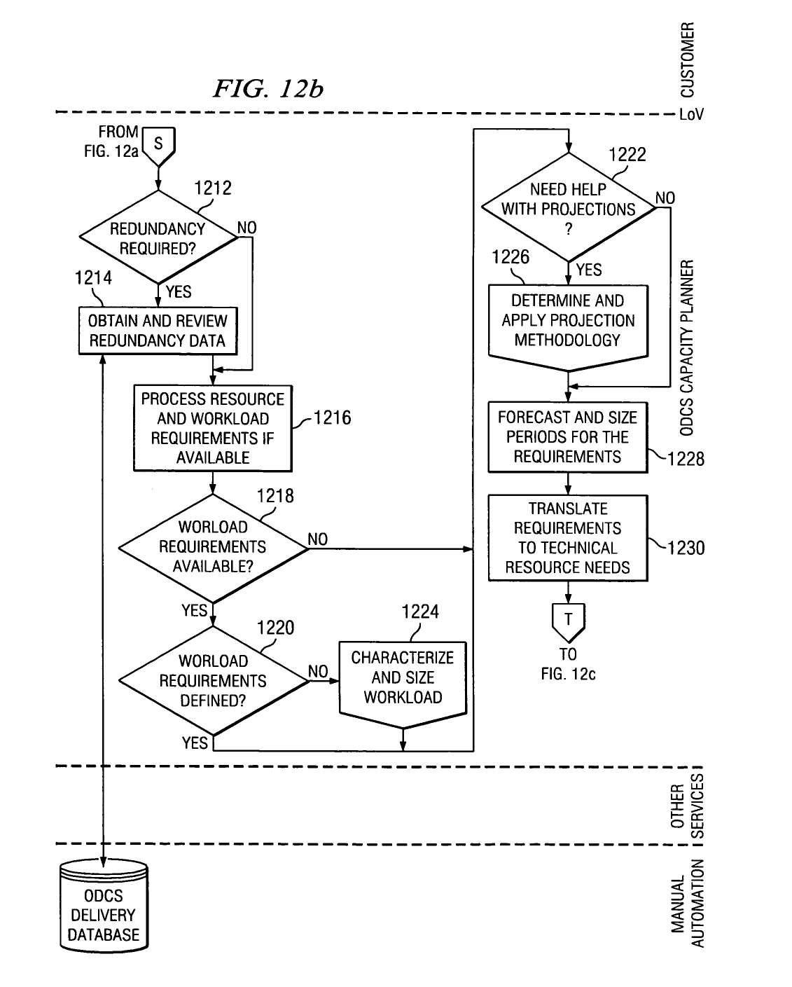

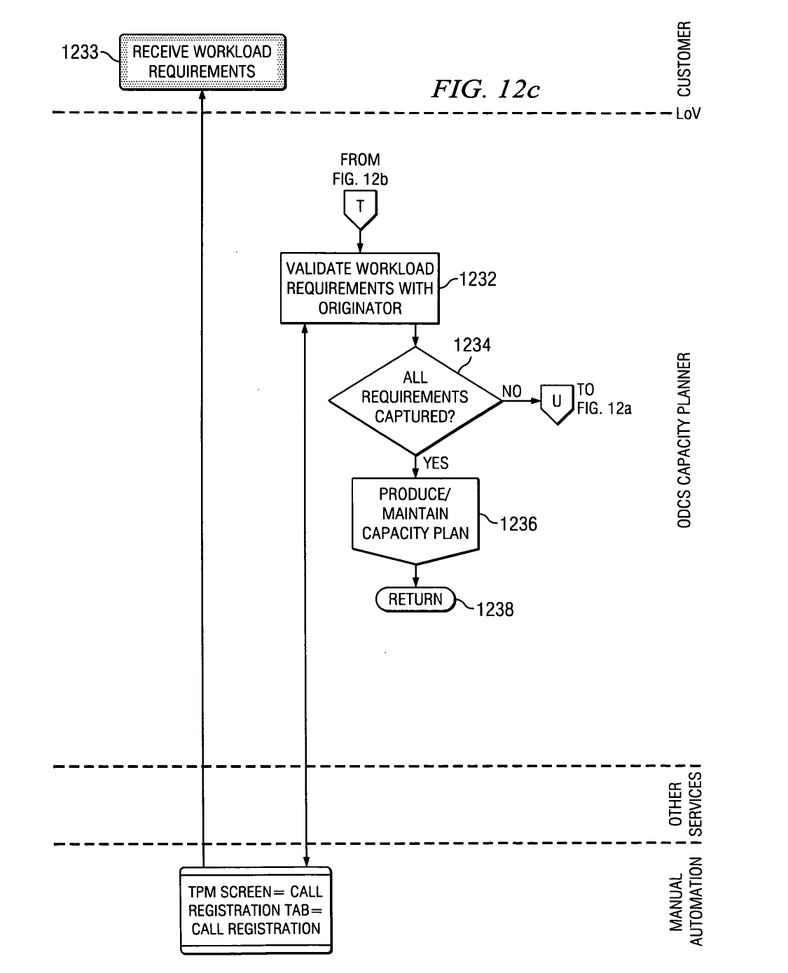

FIG. 12 illustrates the Forecast Resource Requirements sub-process. A indicated above and noted in FIG. 12, the Forecast Resource Requirements sub-process is invoked by the Handle Control Capacity Request sub-process. The objective of the Forecast Resource Requirements sub-process is to project system resource requirements based on future customer capacity requirements.

The Capacity Planner begins the Forecast Resource Requirements sub-process by gathering resource and workload requirements, if available (1202). The information and data should be sufficient to allow the Capacity Planner to forecast the magnitude and size of future workload requirements, as well as the cycles and periods when the requirements will occur over time. As used here, the term “magnitude” means the rate of change in capacity based on usage, and the term “size” refers to the difference in change from the current condition to the condition that will be required in the future. The Capacity Planner can take various approaches to gathering requirements, including: a dialog with the customer via an account manager, historical trends, input from other processes, and input from change or problem records. Customer requirements provide a statement of resource and workload requirements for existing or new customers. These requirements may develop during the course of the year as routine business, or as a result of trend analysis.

After gathering resource and workload requirements, the Capacity Planner obtains load requirements (1204). Load requirements are identified by a workload increase or decrease that can only be addressed by additional capacity.

After obtaining load requirements, the Capacity Planner obtains historical trends (1206), including: resource utilization and usage data that represents a useful period of history for trending purposes; information and data obtained from a customer representative that is supportive in explaining future resource and workload requirements; usage information developed from an existing workload or application that has similar characteristics to a new workload requirement; information and data reflecting system overhead requirements for future resources and workloads; and usage information extracted from a test system during initial testing.

If the Capacity Planner identifies a new workload, then the Capacity Planner obtains and reviews workload data (1208 and 1210). After obtaining and reviewing workload data, or if no new workload is identified, the Capacity Planner determines if redundancy is required (1212). If the Capacity Planner determines that redundancy is required, the Capacity Planner obtains and reviews redundancy data (1214). In the preferred embodiment, the redundancy data includes data for systems that have high availability requirements and require redundant back-up capabilities. Back-up situations must be planned to provide adequate resources for the most critical workloads. Planning for balanced resource utilization is done much the same way for a back-up environment as it is for the business-as-usual environment. One difference, though, would be the decision process of keeping some work off the resource in order to maintain performance for critical workload.

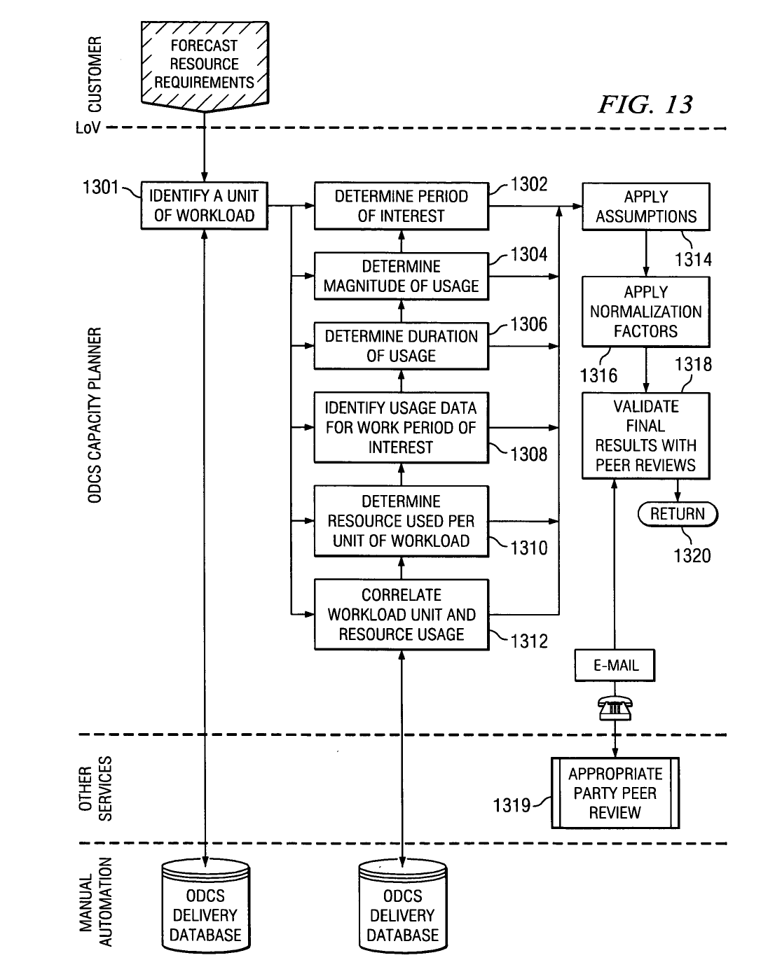

The Capacity Planner then processes the resource and workload requirements, if available (1216). A person of skill in the art will appreciate that not all computing platforms support detailed workload information. A person of skill in the art will also appreciate that various approaches can be used to process requirements to ensure that the requirements, as received, can be successfully and correctly translated into the appropriate technical resource requirements. Key considerations for processing forecast requirements include, without limitation, the magnitude of customer resource requirements and the timing of customer resource requirements. If workload information is available on the desired computing platform, then the Capacity Planner decides if the workload requirements are completely understood and defmed (1220). If not, the Capacity Planner invokes the Characterize and Size Workload sub-process (1224) to identify and quantify a unit of workload, and to determine the magnitude of resources used by such workloads. The Characterize and Size Workload sub-process is illustrated in FIG. 13 and described in detail below.

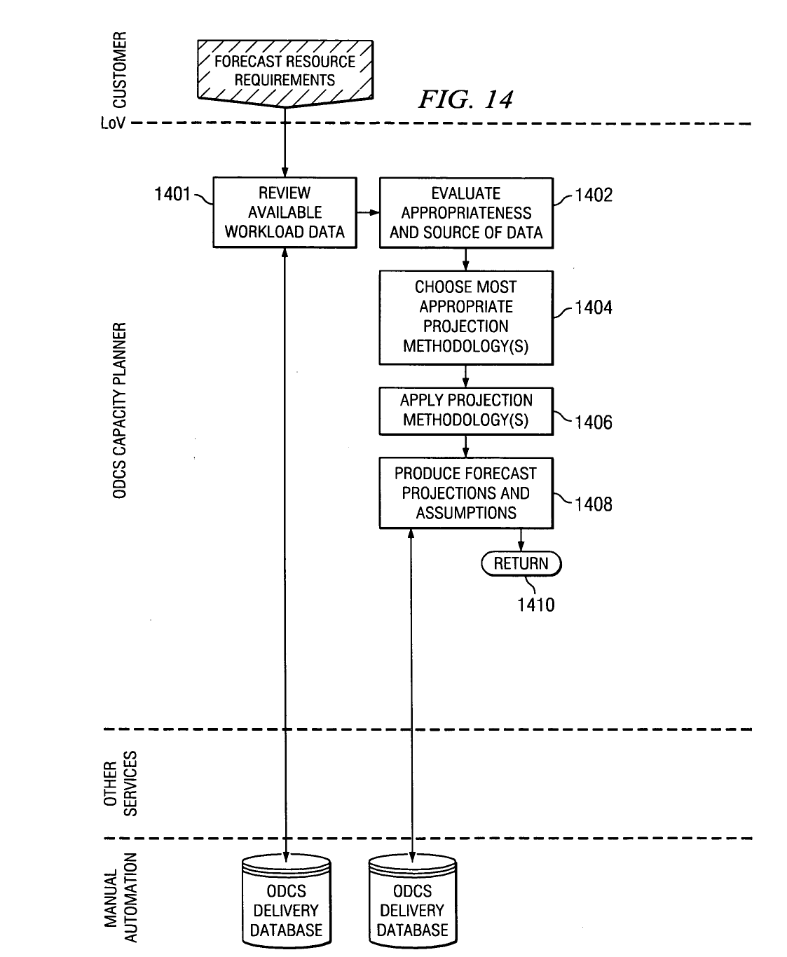

If workload requirements are completely understood and defined, or alternatively, not available, then the Capacity Planner determines if additional help is needed to make projections (1222). If additional help is needed, the Capacity Planner invokes the Determine and Apply Projection Methodology sub-process (1226). The Determine and Apply Projection Methodology sub-process is illustrated in FIG. 14 and described in detail below. If help is not needed, or if the Determine and Apply Projection Methodology sub-process has been completed, then the Capacity Planner forecasts and sizes periods for the requirements (1228).

The Capacity Planner then translates the projected requirements into technical resource needs (1230). The Capacity Planner must also validate the requirements, including the magnitude and timing of the resource requirements (1232). After requirements are gathered from the customer, they are reviewed by the Capacity Planner to ensure that all required information has been supplied (1234). If additional information is required, or if the requirements seem unrealistic, then meetings with a customer representative will ensure better understanding of the customer's future workload.

Once the Capacity Planner and the requester (a customer or a customer representative) have mutually agreed on the requirements, then the Capacity Planner proceeds to develop an appropriate Capacity Plan and supporting assumptions (1236). During this validation step, it is appropriate to formalize a list of supporting assumptions and any associated risks that justify and clarify the requirements.

FIG. 13 illustrates the Characterize and Size Workloads sub-process. As indicated in FIG. 13, the Characterize and Size Workloads sub-process is invoked by the Forecast Resource Requirements sub-process. The objective of the Characterize and Size Workloads sub-process is to identify and quantify a unit of workload or a collection of workload, and determine the magnitude of resources used by such workloads. As used herein, the term “unit of workload” refers to the amount of work that can be performed in a specific period.

As indicated in FIG. 13, the following steps in the Characterize and Size Workloads sub-process may be performed in parallel or in any random order. To characterize and size workloads, the Capacity Planner must determine the appropriate period of interest, such as a shift or a period of business activity (1302). The Capacity Planner must also determine the magnitude and duration of usage (1304 and 1306), as well as identify the data that will be used for the analysis (1308). Finally, the Capacity Planner must determine the amount of resource used per unit of workload (1310) and correlate the resource usage with the workload unit (1312).

After completing the steps above, the Capacity Planner applies assumptions, most likely from a customer representative, concerning the workload periods, intended use of workload, and the magnitude of user access (1314). The Capacity Planner then applies normalization factors to standardize all units of measure (1316). Finally, the Capacity Planner validates the results with peer reviews (1318 and 1319).

FIG. 14 illustrates the Determine and Apply Projection Methodology sub-process. As indicated in FIG. 14, the Determine and Apply Projection Methodology sub-process is invoked by the Forecast Resource Requirements sub-process. The objective of the Determine and Apply Projection Methodology is to evaluate the appropriateness and source of data and to choose the most applicable methodology, or methodologies, for projecting resource requirements.

The first step is to review the data that has been collected (1401), and then evaluate the appropriateness and source of the data (1402). When evaluating the appropriateness and source of data, the Capacity Planner should consider the Capacity Planner's confidence in the raw data provided, the Capacity Planner's confidence in the customer input, and the Capacity Planner's consideration of whether the identified period accurately reflects an appropriate planning period for projections.

After evaluating the appropriateness and source of data, the Capacity Planner chooses the most appropriate projection methodology or methodologies to apply (1404). Common projection methodologies include, without limitation, business drivers, linear regression, linear/non-linear, percent change, direct customer input, and historical trend data. “Business drivers” relate business elements (e.g. number of orders, number of inquiries, etc.) to system usage. The algorithm for converting business elements to system usage is developed by the Capacity Planner from information relating to the business element provided by a customer representative. If this methodology is used, the element defined as the business driver will need to be tracked periodically. The algorithm developed should also be calibrated periodically to ensure it continues to correctly track the business driver to system usage. “Linear regression” is a mathematical analysis of data points where the magnitude and the occurrence of the values are used to develop a regression line. This method is extremely helpful when analyzing historical data that does not seem to be linear. The “linear/non-linear methodology” is the most straight-forward approach for building a forecast based on historical data. Linear projections should be used when the data shows a consistent increase or decrease. Non-linear projections should be applied when future usage is viewed as having specific non-linear usage. This is usually true when there are several variables used in the projection. “Percent change” is the projection method of using a specific percent for depicting increasing or decreasing projections for many different points in time (e.g. a −2% increase in 1Q, 5% increase in 4Q, etc.). Direct customer input refers to instances when a customer provides the actual forecast directly to the Capacity Planner. Direct customer input should only be used when the customer has proven that the forecast has accurately tracked their usage. When analyzing requirements that are to be added to existing workloads, the historical data for the related workload should also be factored into the forecast. Any trend found in the historical data should be applied to the new workload. Examples are increasing or decreasing activity, seasonal trends, or business cycles.

Finally, after choosing the appropriate projection methodology or methodologies to implement, the Capacity Planner applies the selected methodology and produces forecast projections and assumptions (1406 and 1408).

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any conmmunications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

Significantly, this invention can be embodied in other specific forms without departing from the spirit or essential attributes thereof, and accordingly, reference should be had to the following claims, rather than to the foregoing specification, as indicating the scope of the invention.

1. A process for managing capacity resources in a shared computing environment comprising the steps of:
producing and maintaining a capacity plan;
handling capacity requests from a requester;
performing analysis review on capacity requests to identify capacity issues; and
executing a problem manager program in a data-processing system to resolve any identified capacity issues
so that a service provider can meet all service obligations.

2. The process of claim 1 wherein producing and maintaining the capacity plan comprises the steps of:
gathering capacity data;
analyzing the capacity data by extracting capacity obligations from a database and comparing the capacity obligations with existing resources to identify capacity obligations that can be met with existing resources, and to identify capacity obligations that require additional resources;
generating the capacity plan for using the identified existing resources and the identified additional resources to meet capacity obligations;
gaining approval for the capacity plan from one or more persons with the authority to commit to the implementation of the capacity plan; and
notifying any parties to the capacity plan of the plan details.

3. The process of claim 2 wherein gathering capacity data comprises the steps of:
determining capacity data requirements;
determining suppliers of the capacity data;
determining if the capacity data is already available;
acquiring the capacity data from the database;
validating the capacity data;
determining if there is a regular need for the data; and
updating and documenting the database.

4. The process of claim 2 further comprising the steps of:
responsive to determining that the capacity data is not already available,
contacting the capacity data owner;
requesting the capacity data; and
justifying the request for the capacity data to the capacity data owner.

5. The process of claim 2 further comprising the steps of:
before gaining approval for the capacity plan, designing a configuration to support the capacity plan; and
testing the designed configuration to determine if the configuration is capable of balancing a workload as required to meet existing and anticipated capacity obligations.

6. The process of claim 2 further comprising the step of, before gaining approval for the capacity plan, analyzing the performance impact of the capacity plan by determining the impact to the components of the capacity plan during the plan period.

7. The process of claim 1 wherein handling a capacity request comprises the steps of:
analyzing the capacity request with a problem management program;
extracting the requester's entitlements and standard data from a database;
determining if the requester is entitled to have the capacity request satisfied;
responsive to determining that the requester is entitled to have the capacity request satisfied, determining if any non-standard data is required to satisfy the capacity request;
responsive to determining that non-standard data is required to satisfy the capacity request, submitting a request for the non-standard data to a collection team, receiving the non-standard data from the collection team, and reviewing the non-standard data received from the collection team;
analyzing the capacity plan against actual usage data; and
updating the capacity plan to reflect the result of the capacity request.

8. The process of claim 7 wherein analyzing the capacity plan against actual usage data comprises the steps of:
obtaining plan data from the database;
obtaining actual usage data from the database;
comparing the plan data with actual usage data;
determining from the comparison if the actual usage data deviates from the plan data; and
responsive to determining that the actual usage data deviates from the plan data, investigating the deviations.

9. The process of claim 8 wherein investigating the deviations comprises the steps of:
determining if the deviation is the result of an anomaly; and
responsive to determining that the deviation is a result of an anomaly, documenting the deviation.

10. The process of claim 8 wherein investigating the deviations comprises the steps of:
determining if the deviation is the result of a business cycle;
responsive to determining that the deviation is the result of a business cycle, documenting the deviation.

11. The process of claim 8 wherein investigating the deviations comprises the steps of:
determining if the deviation is the result of bad data capture; and
responsive to determining that the deviation is the result of a bad data capture, documenting the bad data capture details with a problem management program and documenting the deviation with a problem management program.

12. The process of claim 8 wherein investigating the deviations comprises the steps of:
determining if the deviation is the result of an unknown reason; and
responsive to determining that the deviation is the result of an unknown reason,
documenting the deviation with a problem management program,
determining if the deviation is likely to re-occur, and
responsive to determining that the deviation is likely to re-occur, documenting the required capacity plan changes.

13. The process of claim 1 wherein handling a capacity request comprises the steps of:
analyzing the capacity request with a problem management program;
extracting the requester's entitlements and standard data from a database;
determining if the requester is entitled to have the capacity request satisfied;
responsive to determining that the requester is entitled to have the capacity request satisfied, determining if any non-standard data is required to satisfy the capacity request;
responsive to determining that non-standard data is required to satisfy the capacity request, submitting a request for the non-standard data to a collection team, receiving the non-standard data from the collection team, and reviewing the non-standard data received from the collection team;
managing capacity data for reporting;
determining if new or changed reports are required;
responsive to determining that new or changed reports are required, running reports; and
updating the capacity plan to reflect the result of the capacity request.

14. The process of claim 13 wherein managing capacity data for reporting comprises the steps of:
determining the data required for generating reports;
determining if additional data elements are needed for generating reports;
responsive to determining that additional data elements are needed for generating reports,
requesting the additional data elements from a data collection team, and
responsive to receiving the additional data elements from the data collection team, validating the additional data elements;
determining the report format;
determining the frequency and date of reporting;
determining the destination for the report; and
notifying a report recipient when the report is available for retrieval from a database.

15. The process of claim 13 wherein running reports comprises the steps of:
extracting report specifications from the database;
creating pre-defined reports with a reporting program;
determining if the report format or report content requires correction;
responsive to determining that the report requires correction, making the required changes to the report; and
distributing reports to one or more report recipients.

16. The process of claim 1 wherein handling a capacity request comprises the steps of:
analyzing the capacity request with a problem management program;
extracting the requester's entitlements and standard data from a database;
determining if the requester is entitled to have the capacity request satisfied;
responsive to determining that the requester is entitled to have the capacity request satisfied, determining if any non-standard data is required to satisfy the capacity request;
responsive to determining that non-standard data is required to satisfy the capacity request, submitting a request for the non-standard data to a collection team, receiving the non-standard data from the collection team, and reviewing the non-standard data received from the collection team;
analyzing trends; and
updating the capacity plan to reflect the result of the capacity request.

17. The process of claim 16 wherein analyzing trends comprises the steps of:
identifying relevant trends;
obtaining historical capacity data from the database;
determining if a specific analysis is required;
responsive to determining that a specific analysis is required, determining if additional capacity data is available,
responsive to determining that additional capacity data is not available, requesting the additional capacity data from a collection team;
obtaining the additional capacity data;
selecting resource types and workload types to identify trends;
responsive to identifying trends, documenting the trends in the database;
determining if any identified trends deviate from the capacity plan; and
responsive to determining that one or more identified trends deviates from the capacity plan, investigating the deviations.

18. The process of claim 17 wherein investigating the deviations comprises the steps of:
determining if the deviation is the result of an anomaly; and
responsive to determining that the deviation is a result of an anomaly, documenting the deviation.

19. The process of claim 17 wherein investigating the deviations comprises the steps of:
determining if the deviation is the result of a business cycle;
responsive to determining that the deviation is the result of a business cycle, documenting the deviation.

20. The process of claim 17 wherein investigating the deviations comprises the steps of:
determining if the deviation is the result of bad data capture; and
responsive to determining that the deviation is the result of a bad data capture, documenting the bad data capture details with a problem management program and documenting the deviation with a problem management program.

21. The process of claim 17 wherein investigating the deviations comprises the steps of:
determining if the deviation is the result of an unknown reason; and
responsive to determining that the deviation is the result of an unknown reason, documenting the deviation with a problem management program,
determining if the deviation is likely to re-occur, and
responsive to determining that the deviation is likely to re-occur, documenting the required capacity plan changes.

22. The process of claim 1 wherein handling a capacity request comprises the steps of:
analyzing the capacity request with a problem management program;
extracting the requester's entitlements and standard data from a database;
determining if the requester is entitled to have the capacity request satisfied;
responsive to determining that the requester is entitled to have the capacity request satisfied, determining if any non-standard data is required to satisfy the capacity request;
responsive to determining that non-standard data is required to satisfy the capacity request, submitting a request for the non-standard data to a collection team, receiving the non-standard data from the collection team, and reviewing the non-standard data received from the collection team;
analyzing commitments and thresholds;
determining if threshold changes are required;
responsive to determining that threshold changes are required, using a problem manager program to determine the new threshold value; and
updating the capacity plan to reflect the result of the capacity request.

23. The process of claim 22 wherein analyzing commitments and thresholds comprises the steps of:
obtaining operational trend data from the database;
obtaining capacity and performance objectives from the database;
obtaining service level attainment and customer satisfaction data from the database;
determining if any service commitments have been missed;
responsive to determining that one or more service commitments have been missed, determining resource usage at the time of the missed service commitment;
reviewing thresholds against current service commitments;
determining if threshold changes are required;
responsive to determining if threshold changes are required, documenting the required threshold changes;
determining if capacity plan changes are required; and
responsive to determining that capacity plan changes are required, updating the capacity plan to reflect the required changes.

24. The process of claim 1 wherein handling a capacity request comprises the steps of:
analyzing the capacity request with a problem management program;
extracting the requester's entitlements and standard data from a database;
determining if the requester is entitled to have the capacity request satisfied;
responsive to determining that the requester is entitled to have the capacity request satisfied, determining if any non-standard data is required to satisfy the request;
responsive to determining that non-standard data is required to satisfy the capacity request, submitting a request for the non-standard data to a collection team, receiving the non-standard data from the collection team, and reviewing the non-standard data received from the collection team;
forecasting resource requirements; and
updating the capacity plan to reflect the result of the capacity request.

25. The process of claim 24 wherein forecasting resource requirements comprises the steps of:
gathering resource and workload requirements;
obtaining load requirements from the database;
obtaining historical trends from the database;
characterizing and sizing workload requirements;
determining and applying a projection methodology;
forecasting and sizing periods for the workload requirements;
translating the workload requirements to technical resource needs; and
updating the capacity plan to reflect the technical resource needs.

26. The process of claim 25 wherein characterizing and sizing workload requirements comprises the steps of:
identifying a unit of workload;
determining a period of interest;
determining a magnitude of usage;
determining a duration of usage;
extracting resource usage data from the database for the period of interest;
determining the resource used per unit of workload;
correlating the unit of workload with the resource usage data;
applying assumptions;
applying and normalizing factors; and
validating results with peer reviews.

27. The process of claim 25 wherein determining and applying a projection methodology comprises the steps of:
reviewing available workload data;
evaluating appropriateness and source of workload data;
choosing the most appropriate projection methodology;
applying the chosen projection methodology;
producing forecast projections and assumptions; and
storing the forecast projections and assumptions in the database.

28. The process of claim 1 wherein handling a capacity request comprises the steps of:
analyzing the capacity request with a problem management program;
extracting the requester's entitlements and standard data from a database;
determining if the requester is entitled to have the capacity request satisfied;
responsive to determining that the requester is not entitled to have the capacity request satisfied, documenting the entitlement failure details;
handling the service entitlement failure; and
notifying the requester that the request will not be fulfilled.

29. The process of claim 28 wherein handling the service entitlement failure comprises the steps of:
determining if the capacity request is covered by a contract; and
responsive to determining that the capacity request is not covered by the contract, advising the requester that the capacity request will be cancelled.

30. The process of claim 28 wherein handling the service entitlement failure comprises the steps of:
determining if the capacity request is covered by a contract;
responsive to determining that the capacity request is covered by a contract, determining if the requester is entitled to any available alternatives;
responsive to determining that the requester is entitled to one or more available alternatives, reviewing the available alternatives with the requester to gain acceptance of at least one of the available alternatives; and
responsive to gaining acceptance of at least one of the available alternatives, updating the capacity plan to reflect the result of the capacity request.

31. The process of claim 28 wherein handling the service entitlement failure comprises the steps of:
determining if the capacity request is covered by a contract;
responsive to determining that the capacity request is covered by a contract, determining if the requester is entitled to any available alternatives;
responsive to determining that the requester is not entitled to any available alternatives, obtaining approval for the original request; and
updating the capacity plan to reflect the result of the capacity request.

32. The process of claim 1 embedded in computer program product.

33. A system for managing capacity resources in a shared computing environment comprising:
a service provider;
a plurality of service obligations;
a plurality of capacity resources; and
a capacity planner that
produces and maintains a capacity plan, wherein the capacity plan substantially identifies current and needed capacity resources and substantially describes the allocation of the current and needed capacity resources, and
executes the capacity plan so that the service provider meets all service obligations.

34. The system of claim 32 wherein the capacity planner further handles capacity requests.

35. The system of claim 33 wherein the capacity planner further reviews capacity requests to identify capacity issues that should be resolved in a future capacity plan.

36. A system for managing capacity resources in a shared computing environment comprising:
a service provider;
a plurality of service obligations;
a plurality of capacity resources;
means for producing and maintaining a capacity plan;
means for handling capacity requests; and
means for reviewing capacity requests to identify capacity issues.
